(19) United States
(12) Patent Application Publication
(10) Pub. No.: US 2010/0127871 A1
(43) Pub. Date: May 27, 2010

(54) SYSTEM AND METHOD FOR VERIFICATION OF SHIPPED PRODUCTS USING RFID TAGS

(75) Inventor: Massimo Pontin, Feltre (IT)

Correspondence Address: MCANDREWS HELD & MALLOY, LTD, 500 WEST MADISON STREET, SUITE 3400, CHICAGO, IL, 60661, US

(73) Assignee: Pontin SRL, Feltre (IT)

(21) Appl. No.: 12/323,740

(22) Filed: Nov. 26, 2008

(51) Int. Cl. G08B 13/14

(52) U.S. Cl. 340/572.1

(57) ABSTRACT

Certain embodiments of the present invention provide a system for verifying the shipment of goods including: a supplier terminal for scanning an RFID tag with a identifier, and for generating associated information corresponding to the RFID tag, wherein the RFID tag is attachable to a container, the supplier terminal further including a camera for taking a photograph, wherein the associated information includes the photograph; and a receiver terminal for scanning the RFID tag, and for retrieving the associated information from the RFID tag; and a tracking management platform for communicating with the supplier terminal and the receiver terminal and for maintaining the associated information. In an embodiment, the photograph includes an image of the goods within a container. In an embodiment, the associated information includes customs documentation. In an embodiment, the receiver terminal is also for generating additional of the associated information corresponding to the RFID tag. In an embodiment, the supplier and receiver terminals include an operator input for allowing a terminal operator to input at least a portion of the associated information.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present application relate generally to the verification of shipped goods using radio frequency identification (RFID) tags. Particularly, certain embodiments relate to using photographs in conjunction with RFID tags to verify the contents of goods shipped in a container.

Many goods are shipped from distant locations, such as from different countries. There are often various parties involved in the shipping of goods. For example, there is a supplier and a receiver. There may additionally be a broker or other agents who have an interest in the transaction and shipping of goods. Of course, there are many types of goods. One such good discussed in the present application is waste paper, although other goods are also conceivable. It is not uncommon for waste paper to be shipped long distances to a location where it will be reprocessed.

Typically, goods are shipped in containers. Tracking and quality control systems are often implemented to efficiently transact goods through long distance shipping. Quality control and tracking, for example, can be important for improving the confidence of the various parties that the transaction will be efficient and fair. Some goods, such as waste paper, may have various grades or qualities. This may present additional complexity to the transaction.

In addition to the parties with a financial interest in the transaction, other parties may also be involved in the long distance shipping of goods. International shipping, for example, may involve governmental authorities, such as customs other law enforcement agents. Also, there may be intermediate parties, such as transporters or warehouses, for example. The additional parties may require compliance with laws, procedures, regulations, and the like.

Throughout the shipping process, it may be inefficient for an interested party—e.g., a waste paper broker—to be present at the various locations.

### BRIEF SUMMARY OF THE INVENTION

Certain embodiments of the present invention provide a system for verifying the shipment of goods including: a supplier terminal for scanning an RFID tag with a identifier, and for generating associated information corresponding to the RFID tag, wherein the RFID tag is attachable to a container, the supplier terminal further including a camera for taking a photograph, wherein the associated information includes the photograph; and a receiver terminal for scanning the RFID tag, and for retrieving the associated information from the RFID tag; and a tracking management platform for communicating with the supplier terminal and the receiver terminal and for maintaining the associated information. In an embodiment, the photograph includes an image of the goods within a container. In an embodiment, the associated information includes customs documentation. In an embodiment, the receiver terminal is also for generating additional of the associated information corresponding to the RFID tag. In an embodiment, the supplier and receiver terminals include an operator input for allowing a terminal operator to input at least a portion of the associated information. In an embodiment, the supplier and receiver terminals include a personal digital assistant. In an embodiment, the associated information includes at least one of: a container number; a seal number; a tag number; a load date; a weight; a number of pieces; and a note. In an embodiment, the tracking management platform permits a user to view the associated information, and is configured to prohibit access to a portion of the associated information based on an identity of the user.

Certain embodiments of the present invention provide a terminal including: a scanner for scanning an RFID tag attachable to a container of goods; a camera for taking a photograph, the photograph including associated information corresponding to the container; an operator input for allowing an operator to enter additional of the associated information; and a communications interface for communicating the associated information with a tracking management platform. In an embodiment, the terminal includes a personal digital assistant. In an embodiment, the personal digital assistant and the camera are integrated. In an embodiment, the associated information is synchronized between the terminal and the tracking management platform. In an embodiment, the terminal is capable of operating in a supplier mode and a receiver mode. In an embodiment, the supplier mode permits the operator to enter the associated information, and wherein the receiver mode permits the operator to verify the associated information.

Certain embodiments of the present invention provide a method of tracking a shipping of a shipment of goods, the method including: applying an RFID tag to the shipment by a supplier, the RFID tag including a identifier; scanning the RFID tag with a supplier terminal to retrieve the identifier; photographing the shipment with the supplier terminal, and associating the photograph with the identifier to form associated information; entering additional of the associated information with the supplier terminal; communicating the associated information from the supplier terminal to a tracking management platform; receiving the shipment by a receiver; scanning the RFID tag with a receiver terminal to retrieve the identifier; communicating the identifier from the receiver terminal to the tracking management platform; retrieving the associated information from the tracking management platform to the receiver terminal; and verifying the shipment by comparing the shipment with the associated information including the photograph. In an embodiment the method further includes providing the option for the receiver to reject the shipment if the associated information does not sufficiently match the shipment. In an embodiment the method further includes logging onto the tracking management platform by a plurality of users to view the associated information. In an embodiment, the users include the supplier, the receiver, and a broker. In an embodiment, the users can view a different amount of the associated information based on the identity of each of the users. In an embodiment the method further includes entering additional of the associated information at the receiver terminal.

### BRIEF DESCRIPTION OF SEVERAL VIEWS OF THE DRAWINGS

FIG. 1 shows a system for tracking the shipment of goods, according to an embodiment of the present invention.

FIG. 2 shows a method for tracking the shipment of goods, according to an embodiment of the present invention.

FIG. 3 shows a conceptual diagram for tracking the shipment of goods, according to an embodiment of the present invention.

The foregoing summary, as well as the following detailed description of certain embodiments of the present application, will be better understood when read in conjunction with the appended drawings. For the purpose of illustrating the invention, certain embodiments are shown in the drawings. It should be understood, however, that the present invention is not limited to the arrangements and instrumentality shown in the attached drawings. Further, some figures may be representations of the type of display and/or output associated with methods and systems of the present invention, in accordance with one or more embodiments.

### DETAILED DESCRIPTION OF THE INVENTION

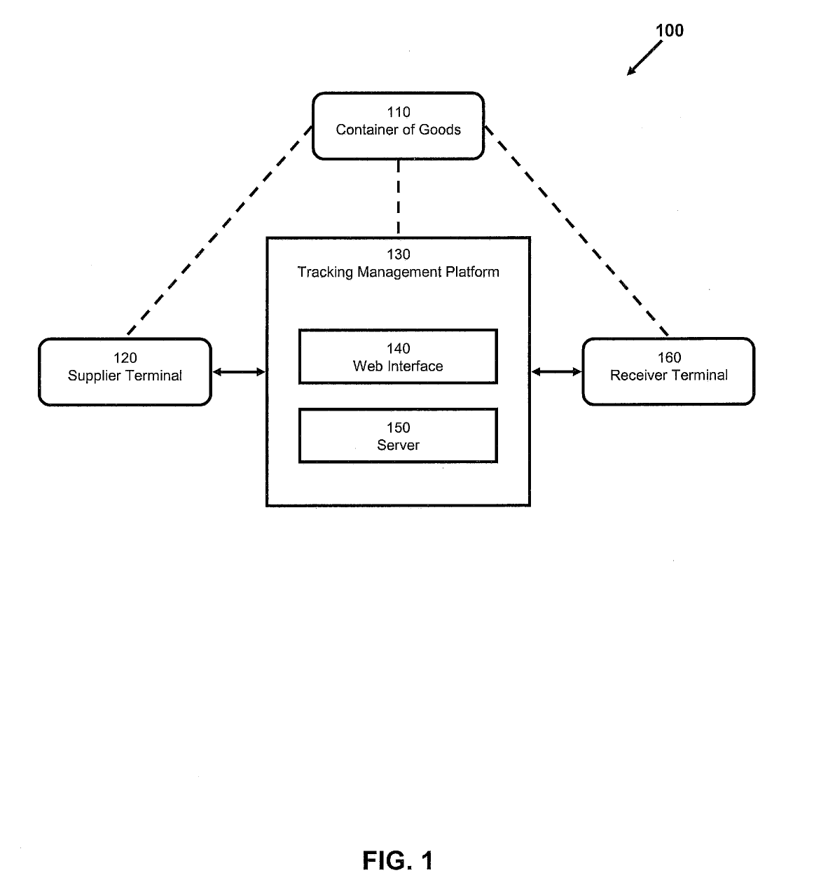

FIG. 1 shows a system 100 for tracking the shipment of goods, according to an embodiment of the present invention. The system 100 may include a supplier terminal 120, a receiver terminal 160, a tracking management platform 130 having a web interface 140 and a server 150. Also shown is a container of goods 110, although the container is not necessarily part of the system 100, it may be helpful to visualize how the system 100 interplays with the container 110.

The system 100 is configured to manage the shipping process for the container of goods 110. The container of goods 110 may be any of a number of types of containers, and may hold various types of goods. In one example, the container is a 40 foot container, and the enclosed good is waste paper for recycling. The goods may be of varying quality or quantity. For example, with respect to waste paper, varying qualities may include: old corrugated cardboard (OCC), magazines, over issued news paper (OINP), mixed waste, or any of the grades listed by the European Standard EN643 or in by Paper Stock Industries (PSI).

The supplier terminal 120 and receiver terminal 160 may be similar. For example, the supplier and receiver terminals may be the same type of device capable of operating in two modes—a supplier mode and a receiver mode. In some instances, the supplier terminal 120 may act as a receiver terminal 160 and vice versa. Generally, the terminal may be capable of scanning RFID tags or bar codes. In an embodiment, the terminal is a personal digital assistant (PDA) or a similar type of device.

The terminal may provide a user input. For example, the terminal may have a keypad, keyboard, number pad, touch screen, mousing device, voice recognition, and/or the like. The terminal may also have a camera, such as a digital camera.

The terminal may also have additional features. The terminal may have, for example, modular components that are repeatedly engageable, such as snap-on components. For example, the terminal may have a magnetic stripe reader or a trigger handle. The additional features and/or components may also be integrated into the terminal. The camera and/or user input may also be modular or may be integrated.

The terminal may also communicate with the tracking management platform 130. The communications interface may be a wired or wireless one. As an example, the communications interface from the terminal is a USB port. Under such an example, information may be transferred from the terminal to a linked computer, from which the information is communicated to a centralized server using internet protocol. The terminal may be able to upload and/or download information from the platform 130. As an example, the terminal may be able to “synchronize” with the platform 130.

A terminal operator may be able to scan an RFID tag on a container 110. Further, the terminal operator may be able to enter information corresponding to the container 110, and to associate the information with the container 110.

For example, for a supplier terminal 120, the terminal operator may be able to initialize the RFID tag and link the RFID serial number to an order number, for example. The terminal operator may be able to enter and/or associate with the container 110 the following types of information: container number, a seal number, a tag number, a load date, a container weight, a number of pieces, associated comments, legal or other documentation, bills, invoices, notes, and/or the like. The associated information and RFID information may then be uploaded or synchronized with the tracking management platform 130.

The association process may be automated and/or manual. For example, each container may require the same legal documentation for customs. In such a case, the association of the legal documentation with each container may be automated. Additionally, the association process may not require the associated information to be stored in a memory in the terminal. Using the legal documentation example again, the legal documentation may be stored on the platform 130 or at some other memory location, and may be associated (either automatically or manually) with the container 110.

For a receiver terminal 160, the terminal operator may be able to scan the RFID tag to receive the identifier associated with the container 110. The receiver terminal may be able to communicate the identifier with the tracking management platform 130 to retrieve associated information that corresponds to the container 110. The terminal operator may then be able to check the order record data for the container 110. The terminal operator may also be able to associate information with the container 110, much in the same way as the serial terminal 120 operator. The associated information may then be communicated or synchronized with the tracking management platform 130.

As mentioned, the terminal may also have a camera—either modular or integrated. For the supplier terminal 120, the terminal operator may be able to photograph the container 110, the goods inside the container 110, such as bales or rolls of waste paper, for example. The photograph(s) may then be associated with the container 110 vis-à-vis the identifier of the RFID tag. The photographs may also be uploaded or synchronized with the tracking management platform 130.

For the receiver terminal 160, the terminal operator may be able to download or synchronize with the tracking management platform 130 to view the associated photographs. The terminal operator may also be able to take additional photographs and associate the photos much in the same way as described above for the supplier terminal 120.

The shipping process, by definition, starts with a supplier and ends with a receiver. There may also be intermediate stops along the way. For example, the container 110 may go through a warehouse, shipping ports, airports, or customs, for example. A terminal may be located at such an intermediate location. An intermediate terminal may act as a receiver terminal 160, for example.

The tracking management platform 130 may further include a web interface 140 and server 150. As discussed the tracking management platform 130 may communicate with the terminals to upload, download, or synchronize an RFID identifier and associated information. The web interface 140 may be a portal for accessing information stored in the server 150. For example, the interface 140 may be a web portal, or an extranet.

A user may be able to log onto the interface 140, or otherwise gain access to the information stored in the server 150. Different users may be afforded different levels of access to the information stored on the server 150. For example, a supplier, receiver, broker, or customs agent may be able to access different sets of information based on privileges. In addition to tracking information, the interface 140 may provide other information and features, such as currency exchange rates and sales management.

From the interface 140, a user may be able to search for and/or view a container 110 and some or all of the associated information. Additionally, a user may be able to enter and/or associate additional information with the container 110. Optionally, the platform 130 may automatically associate additional information with the container 110. Thus, a software administrator, supplier, receiver, broker or customs agent can track, check and manage shipments.

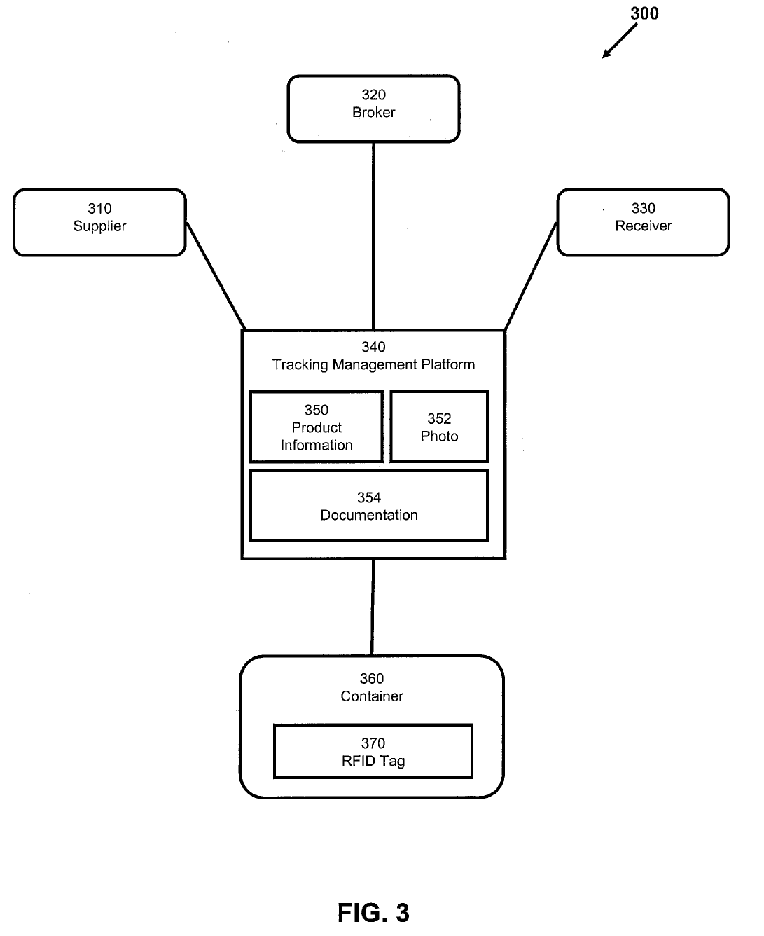

FIG. 3 shows a conceptual diagram 300 for tracking the shipment of goods, according to an embodiment of the present invention. A tracking management platform 340 stores information pertaining to a container 360. The container 360 has an RFID tag 370 applied, which may facilitate the association of information with the container. The information, for example, may include product information 350 (e.g., weight, pieces, goods, notes, etc.), photograph(s) 352, and/or documentation 354 (e.g., legal, customs, billing, notes, etc.). As discussed herein, the content of the information may be entered or updated by various parties, for example: supplier 310, broker 320, receiver 330, or customs agent (not shown). Also, the information may be automatically entered or updated. Each user may be able to view different sets of information based on preference or privilege, for example.

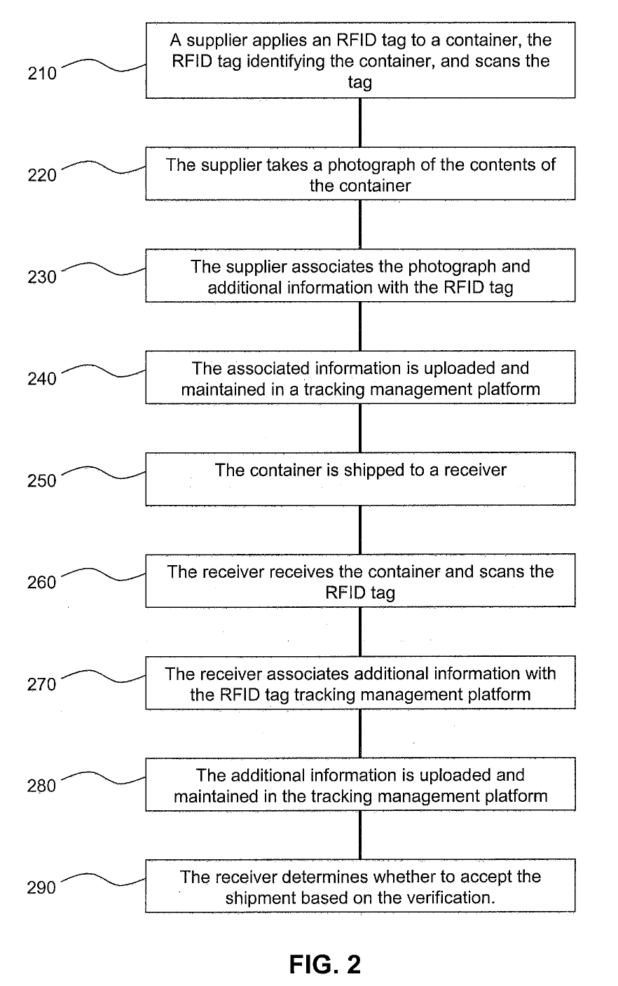

FIG. 2 shows a method 200 for tracking the shipment of goods, according to an embodiment of the present invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. For example, features may be implemented with software, hardware, or a mix thereof. Therefore, it is intended that the invention not be limited to the particular embodiment disclosed, but that the invention will include all embodiments falling within the scope of the appended claims.

What is claimed is:

1. A system for verifying the shipment of goods comprising:
a supplier terminal for scanning an RFID tag with a identifier, and for generating associated information corresponding to said RFID tag, wherein said RFID tag is attachable to a container, said supplier terminal further comprising a camera for taking a photograph, wherein said associated information comprises said photograph; and
a receiver terminal for scanning said RFID tag, and for retrieving said associated information from said RFID tag; and
a tracking management platform for communicating with said supplier terminal and said receiver terminal and for maintaining said associated information.

2. The system of claim 1, wherein said photograph comprises an image of the goods within a container.

3. The system of claim 1, wherein said associated information comprises customs documentation.

4. The system of claim 1, wherein said receiver terminal is also for generating additional of said associated information corresponding to said RFID tag.

5. The system of claim 4, wherein said supplier and receiver terminals comprise an operator input for allowing a terminal operator to input at least a portion of said associated information.

6. The system of claim 5, wherein said supplier and receiver terminals comprise a personal digital assistant.

7. The system of claim 1, wherein said associated information comprises at least one of: a container number; a seal number; a tag number; a load date; a weight; a number of pieces; and a note.

8. The system of claim 1, wherein said tracking management platform permits a user to view said associated information, and is configured to prohibit access to a portion of said associated information based on an identity of said user.

9. An terminal comprising:
a scanner for scanning an RFID tag attachable to a container of goods;
a camera for taking a photograph, said photograph comprising associated information corresponding to said container;
an operator input for allowing an operator to enter additional of said associated information; and
a communications interface for communicating said associated information with a tracking management platform.

10. The terminal of claim 9, wherein the terminal comprises a personal digital assistant.

11. The terminal of claim 10, wherein said personal digital assistant and said camera are integrated.

12. The terminal of claim 9, wherein said associated information is synchronized between the terminal and said tracking management platform.

13. The terminal of claim 9, wherein the terminal is capable of operating in a supplier mode and a receiver mode.

14. The terminal of claim 13, wherein said supplier mode permits said operator to enter said associated information, and wherein said receiver mode permits said operator to verify said associated information.

15. A method of tracking a shipping of a shipment of goods, the method comprising:
applying an RFID tag to the shipment by a supplier, said RFID tag comprising a identifier;
scanning said RFID tag with a supplier terminal to retrieve said identifier;
photographing the shipment with said supplier terminal, and associating said photograph with said identifier to form associated information;
entering additional of said associated information with said supplier terminal;
communicating said associated information from said supplier terminal to a tracking management platform;
receiving the shipment by a receiver;
scanning said RFID tag with a receiver terminal to retrieve said identifier;
communicating said identifier from said receiver terminal to said tracking management platform;
retrieving said associated information from said tracking management platform to said receiver terminal; and
verifying the shipment by comparing the shipment with said associated information including said photograph.

16. The method of claim 15 further comprising providing the option for said receiver to reject the shipment if said associated information does not sufficiently match the shipment.

17. The method of claim 15 further comprising logging onto said tracking management platform by a plurality of users to view said associated information.

18. The method of claim 17, wherein said users comprise said supplier, said receiver,and a broker.

19. The method of claim 17, wherein said users can view a different amount of said associated information based on the identity of each of said users.

20. The method of claim 17 further comprising entering additional of said associated information at said receiver terminal.
